(19) United States
(12) Patent Application Publication
(10) Pub. No.: US 2017/0057015 A1
(43) Pub. Date: Mar. 2, 2017

(54) Methods And Apparatus For Rapidly Manufacturing Three-Dimensional Objects From A Plurality Of Layers

(71) Applicant: Oxford Performance Materials, Inc., South Windsor, CT (US)

(72) Inventors: Scott DeFelice, Holyoke, MA (US); Anthony DeCarmine, Lebanon, CT (US)

(21) Appl. No.: 15/245,715

(22) Filed: Aug. 24, 2016

Related U.S. Application Data
(60) Provisional application No. 62/210,729, filed on Aug. 27, 2015.

(51) Int. Cl. B23K 26/342; B33Y 30/00; B33Y 40/00; B23K 26/70

(52) U.S. Cl. CPC B23K 26/342; B23K 26/702; B33Y 30/00; B33Y 40/00

(57) ABSTRACT

System and method for manufacturing a three-dimensional laminated object from a plurality of laminae. Each lamina is generally planar and has a top surface and a bottom surface. A holder is configured to fix the first lamina relative to the second lamina. A roller is positioned above the table and configured to traverse along a longitudinal axis. The first lamina and the second lamina are positioned between the support and the roller. An actuator biases the roller towards the support to retain the first lamina and second lamina. The biasing forms a fusion zone between the first lamina and the second lamina proximate to the roller. An energy source is configured to emit energy to the fusion zone to fuse the first lamina and the second lamina proximate to the fusion zone.

The present invention relates to the production of large components. More specifically, the present invention relates to the additive fabrication of wing spars via the process of laser fused lamination.

### BACKGROUND

Large aerospace components such as wing spars are typically constructed by traditional machining processes. Such processes require sourcing large foundry castings, which regularly have long lead times. Additionally, it is difficult to work-hold and manipulate the large foundry castings necessary to manufacture large aerospace components. Accordingly, the process is costly and time consuming.

Large aerospace components are also manufactured using traditional laminated object manufacturing (“LOM”). LOM is a rapid prototyping system in which metal laminates are successively glued together and cut to shape with a knife or laser cutter. Objects printed with this technique may be additionally modified by machining or drilling after printing.

A disadvantage LOM is it requires a third body adhesive such as glue or a brazing foil layer that is effective with heat or curing chemistry. The use of an adhesive restricts flexibility in process and forces the existence of an undesired added material and structure differing from the bulk material.

It is also known to manufacture large aerospace components using ultrasonic joining methods. Ultrasonic welding is an industrial technique whereby high-frequency ultrasonic acoustic vibrations are locally applied to workpieces being held together under pressure to create a solid-state weld. A disadvantage of ultrasonic welding techniques is that they limit component flexibility during the manufacturing process and the methods cannot adequately fuse large components.

Large aerospace components are also manufactured utilizing additive manufacturing techniques, which have proven to be a sufficient alternative, as components can be manufactured in a cheap, efficient, and quick manner. Several additive manufacturing techniques have been proposed, such as Sciaky E-Beam and laser sintering, to produce aerospace components. A disadvantage of these techniques, however, is they may still utilize large foundry castings and are unable to sufficiently join together components of larger sizes. Additionally, these methods significantly alter the metallurgy composition of each component and result in a high percentage of HAZ-like material in the final work piece. HAZ or heat-affected zone is the area of base material, either a metal or a thermoplastic, which is not melted and has had its microstructure and properties altered by welding or heat intensive cutting operations. The heat from the welding process and subsequent re-cooling causes this change from the weld interface to the termination of the sensitizing temperature in the base metal. The extent and magnitude of property change depends primarily on the base material, the weld filler metal, and the amount and concentration of heat input by the welding process.

The formation of HAZ is a disadvantage because it significantly weakens the durability and strength of each component. Therefore, the known methods have quality control issues and cannot be reliably utilized in the aerospace industry.

It is an object of the present invention to overcome these disadvantages and other disadvantages associated with the prior art.

Another object the present invention is to provide an improved, less expensive additive manufacturing technique to additively construct high-quality, large components using more accessible processes and more readily available components.

Another object of the present invention is to use an additive manufacturing technique to bypass the need to work with large foundry casings to form aerospace components, including wing spars.

Another object of the present invention is to use manufacturing processes that allows for component flexibility during manufacturing and minimizes undesired material and structure on the resulting final product.

Another object of the present invention is to preserve as much of the original metallurgy as possible and to provide a small fusion zone and minimize HAZ.

### SUMMARY

It is an object of the present invention to provide a system and method that overcomes the problems with the prior art.

These and other objects of the present invention are achieved by a system for manufacturing a three-dimensional laminated object from a plurality of laminae including a first lamina and second lamina. The system includes a support for the first lamina and the second lamina. Each lamina is generally planar and has a top surface and a bottom surface. A holder is configured to fix at least a portion of the first lamina relative to the second lamina so at least a portion of the top surface of the first lamina contacts a least a portion of the bottom surface of the second lamina. A roller is positioned above the table and configured to traverse along a longitudinal axis. The first lamina and the second lamina are positioned between the support and the roller. An actuator biases the roller towards the support to retain the first lamina and second lamina. The biasing forms a fusion zone between the first lamina and the second lamina proximate to the roller. An energy source is configured to emit energy to the fusion zone to fuse the first lamina and the second lamina proximate to the fusion zone.

In yet another embodiment of the present invention, the first lamina and the second lamina are metal.

In yet another embodiment of the present invention, the energy source is a laser and the system includes an imaging system having one or more lenses to direct the light from the laser to the fusion zone.

In yet another embodiment of the present invention, the first lamina and the second lamina have precut cross sections corresponding to a desired cross section of the three-dimensional laminated object.

In yet another embodiment of the present invention, the first lamina and the second lamina include supports and the holder is configured to fix the first lamina to the second lamina via the supports.

In yet another embodiment of the present invention, the holder is configured to align the first lamina relative to the second lamina using one or more of dimensional features of the first and second lamina and optical markings on the first and second lamina.

In yet another embodiment of the present invention the fusion of the first lamina to the second lamina results in thin fusion area leaving 80-90% of the original material in the first lamina and the second lamina unaffected by heat of fusion.

In yet another embodiment of the present invention, the system includes a temperature sensor to monitor the temperature at the area of fusion.

In yet another embodiment of the present invention the system includes a controller that can adjust the energy emitted by the laser based at least in-part the temperature of the area of fusion.

Yet another embodiment of the present provides for a method of manufacturing a three-dimensional work piece from a plurality of laminae including a first lamina and second lamina. The method includes the step of providing a first lamina and a second lamina, each of the lamina having a longitudinal axis. The method includes the further step of fixing at least a portion of the first lamina relative to the second lamina so at least a portion of the top surface of the first lamina contacts a least a portion of the bottom surface of the second lamina. The method includes the step of biasing the first lamina toward the second lamina to create a fusion zone between the first lamina and the second lamina. The fusion zone is perpendicular to the longitudinal axis of the first and the second lamina. The method includes the step of fusing the first lamina to the second lamina at the fusion zone. The method includes the step of advancing the fusion zone along the longitudinal axis of the first and second lamina while continuing to fuse the lamina at the advancing fusion zone so as to substantially fuse the first lamina to the second lamina. This process is repeated by fusing N+1 lamina onto a top surface of each N lamina until the three-dimensional work piece is complete.

In yet other embodiments of the present invention, the first lamina and the second lamina are metal.

In yet other embodiments of the present invention, the method includes the step of fusing the first lamina to the second lamina by a laser.

In yet another embodiment of the present invention, the method includes the step of cutting the first lamina and the second lamina to have a cross section that corresponds to a cross section of the desired three-dimensional object.

In yet another embodiment of the present invention, the cross section of the lamina is cut using one or more of laser cutting, plasma cutting, and waterjet cutting.

In yet another embodiment of the present invention, the method includes the step of providing a roller, wherein the roller biases the first lamina to the second lamina.

In yet another embodiment of the present invention, the method includes the step of providing a holder to align the first lamina relative to the second lamina using one or more of the dimensional features of the first and second lamina and optical markings on the first and second lamina.

In yet another embodiment of the present invention, a thin fusion area is created leaving 80-90% of the original material in the first lamina and the second lamina unaffected by heat of fusion.

In yet another embodiment of the present invention, the method includes the step of monitoring the temperature at the fusion zone.

In yet another embodiment of the present invention, the method includes the step of adjusting the power of the laser based at least in part on the temperature of the fusion zone.

The invention and its particular features and advantages will become more apparent from the following detailed description considered with reference to the accompanying drawings.

### BRIEF DESCRIPTION OF THE DRAWINGS

FIG. 1 is a side view showing a schematic of a system and method in accordance with the present invention.

FIG. 2 illustrates a cross section view of a plurality of lamina.

FIG. 3 illustrates an exploded perspective view of the laminae show in FIG. 2, wherein the laminae have been cut in accordance with dimensions of the desired three-dimensional object.

### DETAILED DESCRIPTION

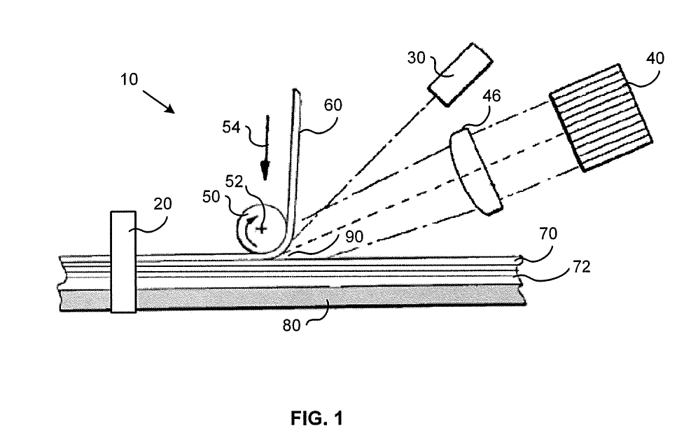

FIG. 1 schematically illustrates a system 10 for the manufacture of objects having various shapes and forms from a plurality of laminae 72. The system 10 uses an energy source 40 to emit energy and direct it to a fusion zone 90. The energy causes the laminae to fuse to each other at the fusion zone 90. The energy source 40 may be any source that can provide sufficient energy to the fusion zone to provide for fusion of the lamina. For example, the energy source 40 may be a CO₂ laser. In some embodiments, the energy source 40 may be a laser array. In the embodiment shown, an optical system 46 is provided for focusing the energy source on fusion zone 90. In some embodiments of the present invention, the fusion zone 90 extends along an axis perpendicular to the longitudinal axis of the lamina 72. The energy source 40 may simultaneously provide energy to the entire fusion zone 90. Alternatively, the optical system 46 can sweep the energy source in the fusion zone 90.

As shown in FIG. 1, several laminae 72 have been welded together and are supported by a table 80. The table supports 80 a plurality of laminae that have been fused together 72, a first lamina 70 and a second lamina 60. In the embodiment shown 10 the first lamina 70 has been fused to a top surface of the existing work piece 72, which comprises the plurality of lamina fused together. The second lamina 60 is welded to the first lamina 70. A person of ordinary skill in the art and familiar with this invention will understand that the invention relates to a system and method for manufacturing an object using N number of layers. After N layer is fused a second N+1 laser is fused. This process is repeated until a desired three-dimensional object is formed.

The system 10 includes a roller 50 that is configured to rotate about a roller axis 82. An actuator 54 biases the roller 50 toward the table 80 so as to compress the first lamina 80 and the second lamina 70 and thereby cause them to come together. In the embodiment shown in FIG. 1, the first lamina 70, the second lamina 60, and the plurality of previously welded lamina 72 are compressed. Proximate to the area where the roller 50 contacts the second lamina 60 a fusion zone 90 is formed. In the embodiment show in FIG. 1, this is the point where the first lamina 70 and the second lamina 60 come together. In the embodiment disclosed, the fusion zone 90 is perpendicular to the longitudinal axis of the first and second lamina 70, 60 and extends generally parallel to the roller axis 52. The roller 50 is configured to rotate about the roller axis 52. The workpiece 72 is supported on the table 80. In FIG. 1, welding table 80 movably supports the workpiece 72 relative to laser 40 and roller 50 for forming complex three dimensional components. Alternatively, laser 40 and roller 50 can be movably supported relative to the workpiece 72 or fixed table 80. In either manner, it is possible to advance the fusion zone 90 along the longitudinal axis of laminae. As the fusion zone 90 is advanced along the longitudinal axis, energy is supplied to the fusion zone 90 to fuse a top surface of the first lamina 70 to a bottom surface of the second lamina 60. By repeating this process with successive lamina is it possible to manufacture a three-dimensional object.

In some embodiments in accordance with the present invention, the laminae are precut in accordance with a desired cross section of the three-dimensional workpiece prior to fusing. This allows the inventive system to build a three-dimensional work piece having a predetermined cross section and thus reduce waste material and minimize post-fusion finishing time. The laminae are precut at a predetermined thickness, appropriate to the part being fused to at least another laminae. In some embodiments of the present invention, the laminae are precut using near-zero-pressure cutting approaches to create kerfless laminae, or other known industrial processes such as laser cutting, plasma cutting, waterjet cutting, and other methods known in the art.

In some embodiments of the present invention, the laminae can be made of metal, metal alloys, thermoplastics, thermoplastics without reinforcement, or any other suitable material.

The system in. FIG. 1 further includes a holder 20 that is configured to fix at least a portion of the first lamina 70 relative to the second lamina 60 so at least a portion of the top surface of the first lamina contacts a least a portion of the bottom surface of the second lamina. In some embodiments of the present invention, the holder 20 is robotically operated using a control system. In some embodiments, the holder uses a geometry of the first lamina 70 and a geometry of the second lamina 60 to align the lamina together in a predetermined fashion so as to facilitate fusing of the pieces in accordance with the desired three-dimensional object. In some embodiments of the present invention optical markings are placed on the laminae. According to one embodiment, a robotic system interprets the markings and places and positions laminae into the holder 20.

The holder 20 may include various locking elements to prevent the laminae from moving relative to each other during fusion. The locking mechanism can comprise a two-part connection system. Alternatively, locking mechanisms can comprise any known locking or connection system known in the art that would stabilize a single or plurality of lamina. In another embodiment, in addition to the holding fixture 20, a nut and bolt system, or another system known in the art can be used to retain the lamina in position.

In some embodiments of the present invention the first and second lamina 70, 60 are provided with supports. A support is a portion of the lamina that extends in the plane of the lamina, but is not intended to be part of the final object. The holder retains the supports supports enabling fusion along the entire surface of the lamina intended to be in the desired three-dimensional object. After the three-dimensional object is formed the supports can be removed.

The actuator 54 is configured to apply pressure onto first and second lamina 60, 70. Applying pressure causes a roll nip at the fusion zone 90. In some embodiments of the present invention, the actuator and/or roller 54 further includes electronics that controls the amount of pressure and the movement of roller 50 when fusing the first and second lamina 60, 70. According to one embodiment, roller 50 moves along the longitudinal axis of the support relative to the support, thereby advancing the fusion zone 90. According to another embodiment, roller element 50 moves separately or in coordination with energy source 40.

The energy source 40 emits an energy beam directed to the fusion zone 90. Energy source 40 may comprise a laser diode array, an electron beam, or another method of depositing energy, and may have a fixed or variable width corresponding to the width of a single lamina or the stacked laminae, or a width of the fusion zone. An energy source controller controls the intensity and width of energy beam. According to one embodiment, the energy source 40 moves along one, or multiple axis while emitting energy towards the fusion zone. According to another embodiment, the energy source 40 may move in conjunction, or separate from roller 40.

With care, the original metallurgy of the stacked laminae can be vastly preserved by emitting energy beam at the fusion zone 90 wherein the fused laminae may comprise 10-20% of a HAZ-like material and 80-90% of the lamina's original material as measured in the thickness of the laminae. The resulting structure resembles that of Damascus Steel or Japanese-forged laminates, both noted through history for their unique combination of hardness and elasticity. For example, in one embodiment of the invention, laminates 100 and 102 may be each 0.1 inches thick. The HAZ-like material resulting from the fusion process may be 0.01 inches thick.

The metallurgy of the stacked laminae can be manipulated by the use of dissimilar metallic strips, strips clad to create differing alloys only at the interface, metal matrix composite elements, and other approaches known to metallurgical art and science. Furthermore, according to another embodiment, the energy source may also be used to finish the surface of the part, by selective superficial re-melting, selective ablation, marking or other finishing approaches.

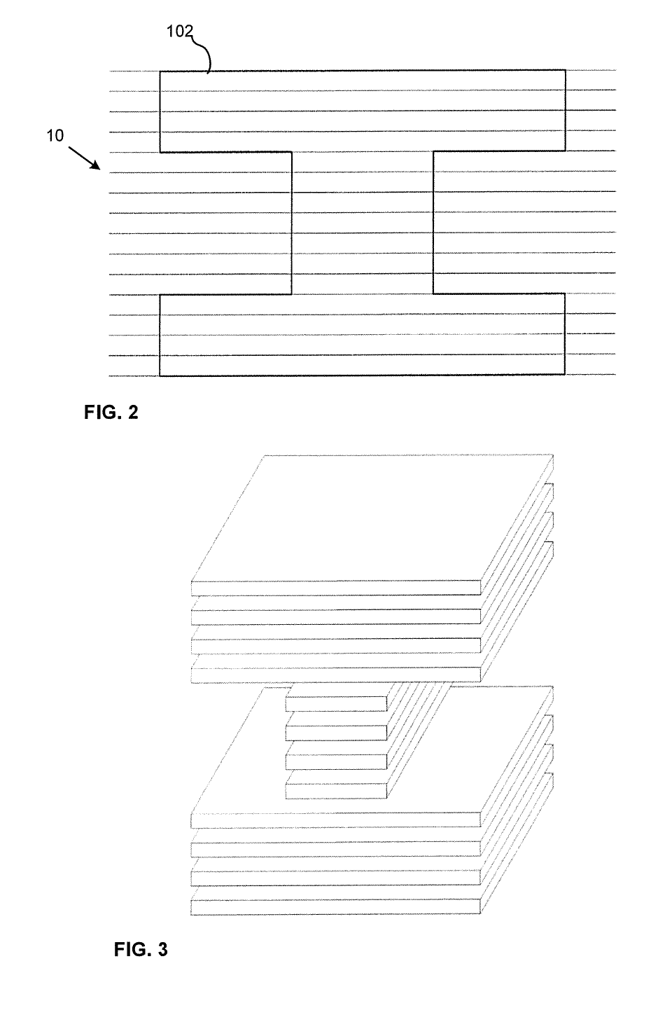

FIG. 2 illustrates a cross section of laminae 100 in accordance with the present invention. The cross section of a desired three dimensional object is illustrated in the form of a cross section of an I-beam in FIG. 2, shown in dark line 102. Each lamina of the plurality of laminae may be precut, as illustrated in FIG. 3, prior to the fusing process. This step saves material and reduces post-fusion finishing.

In some embodiments of the present invention, it is possible to use a prepared laminate, similar to the clad metal described elsewhere, consisting of a thicker transparent (to the energy beam) structural layer bound to a thinner opaque (to energy beam) susceptor layer as feed stock, using the energy beam in a shoot-thru configuration where the beam will penetrate the structural layer without meaningful interaction then to be absorbed by the susceptor layer creating highly localized heat to affect the welding effect. This would preferably be affected mechanically similarly to other examples herein, with a roller system creating a moving nip point so as to exclude bubbles and manage thermal effect more precisely. The compositions of these layers are effectively unlimited, other than that the structural layer is transparent to the beam and adherent to the susceptor layer; that the susceptor layer is opaque to the beam and adherent to the structural layer; and that any interface so created is sound and useful for purpose. Alternatively, this laminate could be supplied to the fabricating system as two separate sheets, fed to the building area by an alternating feed system netting the same effect as the prepared laminate.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for manufacturing a three-dimensional laminated object from a plurality of laminae including a first lamina and second lamina, the system comprising:
a support for the first lamina and the second lamina, each said lamina being generally planar and having a top surface and a bottom surface;
a holder configured to fix at least a portion of the first lamina relative to the second lamina so at least a portion of the top surface of the first lamina contacts a least a portion of the bottom surface of the second lamina;
a roller positioned above the table and configured to traverse along a longitudinal axis, the first lamina and the second lamina being positioned between the support and the roller;
an actuator for biasing the roller towards the support to retain the first lamina and second lamina, the biasing forming a fusion zone between the first lamina and the second lamina proximate to the roller;
an energy source configured to emit energy to the fusion zone to fuse the first lamina and the second lamina proximate to the fusion zone.

2. The system of claim 1, wherein the first lamina and the second lamina are metal.

3. The system of claim 2, wherein the energy source is a laser and the system further comprises an imaging system having one or more lenses to direct the light from the laser to the fusion zone.

4. The system of claim 3, wherein the first lamina and the second lamina have precut cross sections corresponding to a desired cross section of the three-dimensional laminated object.

5. The system of claim 4, wherein the first lamina and the second lamina include supports and the holder is configured to fix lamina to the second lamina via the supports.

6. The system of claim 4, wherein the holder is configured to align the first lamina relative to the second lamina using one or more of the dimensional features of the first and second lamina and optical markings on the first and second lamina.

7. The system of claim 2, wherein only a thin fusion area is created leaving 80-90% of the original material in the first lamina and the second lamina unaffected by heat of fusion.

8. The system of claim 7 further comprising an infrared temperature sensor to monitor the temperature at the area of fusion.

9. The system of claim 8, further comprising a controller, wherein the controller can adjust the energy emitted by the laser based at least in-part the temperature of the area of fusion.

10. A method of manufacturing a three-dimensional work piece from a plurality of laminae including a first lamina and second lamina, the method comprising, including the steps of:
providing a first lamina and a second lamina, each said lamina having a longitudinal axis;
fixing at least a portion of the first lamina relative to the second lamina so at least a portion of the top surface of the first lamina contacts a least a portion of the bottom surface of the second lamina;
biasing the first lamina toward the second lamina to create a fusion zone between the first lamina and the second lamina, the fusion zone being perpendicular to the longitudinal axis of the first and the second lamina;
fusing the first lamina to the second lamina at the fusion zone;
advancing the fusion zone along the longitudinal axis of the first and second lamina while continuing to fuse the lamina at the advancing fusion zone so as to substantially fuse the first lamina to the second lamina;
repeating the fusion process by fusing n+1 lamina onto a top surface of each n lamina until the three-dimensional work piece is complete.

11. The method of claim 10, wherein the first lamina and the second lamina are metal.

12. The method of claim 12, further including the step of fusing the first lamina to the second lamina by a laser.

13. The method of claim 12, further comprising the step of cutting the first lamina and the second lamina to have a cross section that corresponds with a desired cross section of the desired three-dimensional object.

14. The method of claim 13, wherein cross section of the lamina are cut using one or more of laser cutting, plasma cutting, and waterjet cutting.

15. The method of claim 13, further comprising the step of providing a roller, wherein the roller biases the first lamina to the second lamina.

16. The method of claim 15, further comprising the step of providing a holder to align the first lamina relative to the second lamina using one or more of the dimensional features of the first and second lamina and optical markings on the first and second lamina.

17. The method of claim 15, wherein only a thin fusion area is created leaving 80-90% of the original material in the first lamina and the second lamina unaffected by heat of fusion.

18. The method of claim 15 further comprising the step of monitoring the temperature at the fusion zone.

19. The method of claim 18 further comprising the step of adjusting the power of the laser based at least in part on the temperature of the fusion zone.
